(19) United States
(12) Patent Application Publication
(10) Pub. No.: US 2014/0067439 A1
(43) Pub. Date: Mar. 6, 2014

(54) TRAVEL DATA INGESTION AND SESSIONIZATION IN A MULTI-TENANT CLOUD ARCHITECTURE

(71) Applicant: DUETTO RESEARCH, INC., San Francisco, CA (US)

(72) Inventors: Patrick Bosworth, Las Vegas, NV (US); Marco Benvenuti, Las Vegas, NV (US); Craig Weissman, San Francisco, CA (US); Neelav Rana, San Francisco, CA (US)

(73) Assignee: DUETTO RESEARCH, INC., San Francisco, CA (US)

(21) Appl. No.: 13/760,404

(22) Filed: Feb. 6, 2013

Related U.S. Application Data
(60) Provisional application No. 61/713,390, filed on Oct. 12, 2012.
(60) Provisional application No. 61/696,682, filed on Sep. 4, 2012.

(51) Int. Cl. G06Q 10/02

(52) U.S. Cl. CPC G06Q 10/02
USPC 705/5

(57) ABSTRACT

A travel sessionizer captures raw event data from a user device, the raw event data representing user shopping behavior, and parses the raw event data into one or more travel sessions. Each of the one or more travel sessions represents shopping behavior for a single user corresponding to a specified date range. The travel sessionizer denormalizes the one or more travel sessions to organize travel session data by individual property days, where each individual property day represents travel session data corresponding to a separate property on a given day. The travel sessionizer then provides the individual property day data to a profit optimization module for further processing.

### RELATED APPLICATIONS

This application is related to and claims the benefit of U.S. Provisional Application No. 61/713,390 filed on Oct. 12, 2012 and of U.S. Provisional Patent Application No. 61/696,682 filed on Sep. 4, 2012, the contents of both of which are hereby incorporated by reference.

### TECHNICAL FIELD

This disclosure relates to the field of data ingestion, and in particular to travel data ingestion and sessionization in a multi-tenant cloud architecture.

### BACKGROUND OF THE INVENTION

The travel and hospitality industry in the United States and throughout the world is an ever increasing business sector. Advances in Internet and computing technology have significantly increased the opportunities to capture data from both travelers and travel properties (e.g., hotels, motels, bed and breakfasts, condominiums, houses). For example, web site based systems are used to offer the sale and rental of many travel properties and are used to make a large percentage of travel bookings. During these bookings, a significant amount of user travel data is received. The travel data may include, for example, a destination city, specific properties, dates of arrival, length of stay, room type, property amenities, price quotes, availability information, and/or other travel information. Property owners and managers are looking for chances to use this travel data to improve decisions relating to the management and sale of units in their travel properties. The mere availability of this data, however, does not by itself improve decisions that may lead to increased profits for the travel property. Conventional revenue management systems and booking engines are not equipped to make sufficient use of the newly acquired user travel data to deliver actionable insights and analysis as needed.

### BRIEF DESCRIPTION OF THE DRAWINGS

The present invention will be understood more fully from the detailed description given below and from the accompanying drawings of various embodiments of the present invention, which, however, should not be taken to limit the present invention to the specific embodiments, but are for explanation and understanding only.

FIG. 1 is a block diagram illustrating a cloud computing environment for a multi-tenant cloud architecture, according to an embodiment.

FIG. 2 is a block diagram illustrating a travel sessionizer, according to an embodiment.

FIG. 3 is a flow diagram illustrating a shopping data capture method, according to an embodiment.

FIG. 4 is a flow diagram illustrating a travel sessionization method, according to an embodiment.

FIG. 5 is a block diagram illustrating data collection pipelines for travel sessionization, according to an embodiment.

FIG. 6 is a block diagram illustrating a profit optimization module, according to an embodiment.

FIG. 7 is a block diagram illustrating a profit optimization processing flow, according to an embodiment.

FIG. 8 is a block diagram illustrating a demand forecasting processing flow, according to an embodiment.

FIG. 9 is a flow diagram illustrating a demand forecasting method, according to an embodiment.

FIG. 10 is a flow diagram illustrating an error minimization method for demand forecasting, according to an embodiment.

FIG. 11 is a flow diagram illustrating a lost business forecasting method, according to an embodiment.

FIG. 12 is a block diagram illustrating a computer system, according to an embodiment.

### DETAILED DESCRIPTION OF THE PRESENT INVENTION

The following description sets forth numerous specific details such as examples of specific systems, components, methods, and so forth, in order to provide a good understanding of several embodiments of the present invention. It will be apparent to one skilled in the art, however, that at least some embodiments of the present invention may be practiced without these specific details. In other instances, well-known components or methods are not described in detail or are presented in simple block diagram format in order to avoid unnecessarily obscuring the present invention. Thus, the specific details set forth are merely exemplary. Particular implementations may vary from these exemplary details and still be contemplated to be within the scope of the present invention.

Embodiments of a method and apparatus are described for travel data ingestion and sessionization in a multi-tenant cloud architecture. In one embodiment, a cloud-based travel sessionizer captures raw event data from a user device. The raw event data represents user shopping behavior and may include the shopping, browsing, searching, etc., done by a user of the user device. The raw event data may include data associated with the user's search, such as a destination city, specific properties, dates of arrival, length of stay, room type, property amenities, price quotes, availability information, and/or other travel information. This data may be received from multiple users across multiple user devices and for multiple travel searches. The travel sessionizer may parse the received raw event data into one or more travel sessions. Each of the one or more travel sessions may represent shopping behavior for a single user corresponding to a specified date range. For example, the travel sessionizer may examine the raw event data to identify a user performing the search and a set of dates for which the user is searching for travel. Each unique combination may be defined as a separate travel session.

In one embodiment, the travel sessionizer denormalizes the travel session data from the travel sessions to organize the data by individual property days. Each individual property day represents travel session data corresponding to a separate property on a given day and may include travel data from multiple travel sessions (i.e., multiple users on different trips). In one embodiment, when denormalizing the travel session data, the travel sessionizer determines a number of regrets and denials for each of a plurality of properties on each of a plurality of days. A regret occurs in the user shopping behavior when a user is offered a property on a given night for a certain price, but the user does not book the property, and a denial occurs in the user shopping behavior when the user is unable to book a property on the given night. Once denormalized, the travel sessionizer may provide the individual property day data to a profit optimization module for further processing.

The travel data and ingestion techniques described herein allow for the transformation of massive data sets into a usable form. This provides property owners and managers with targeted insights to facilitate well informed and timely decisions that can increase or maximize their profit.

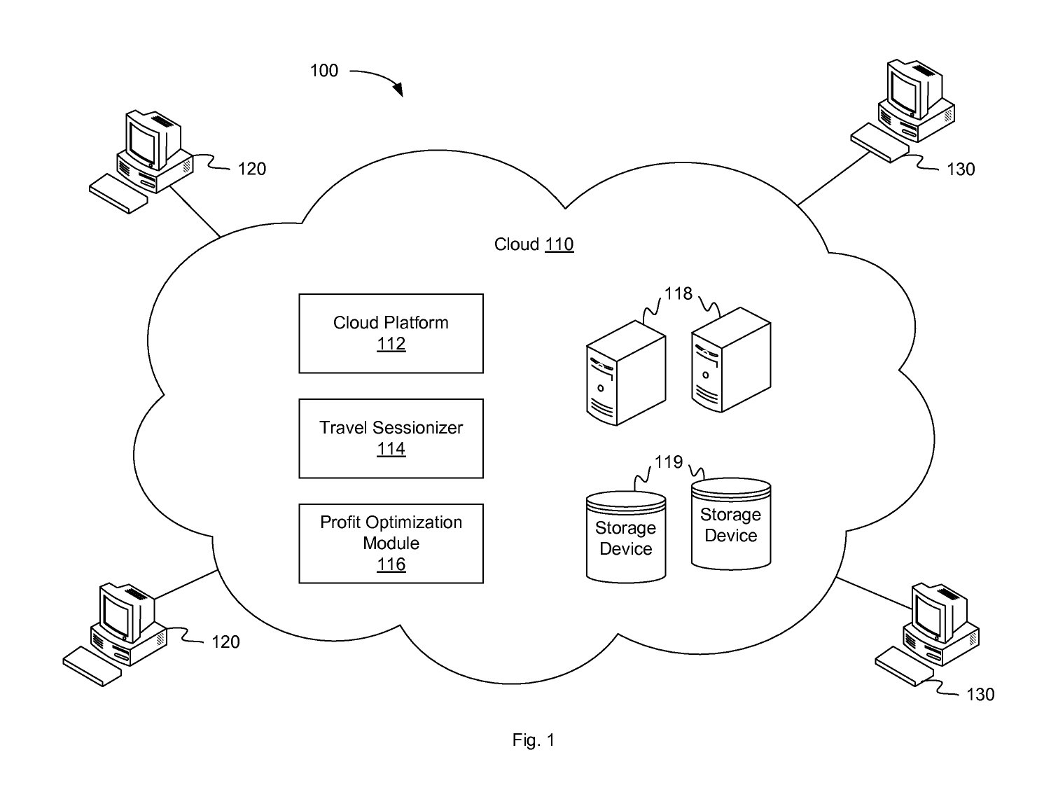

FIG. 1 is a block diagram illustrating a cloud computing environment for a multi-tenant cloud architecture, according to an embodiment of the present invention. In one embodiment, cloud computing environment 100 includes cloud 110, one or more user devices 120, and one or more property devices 130. User devices 120 and property devices 130 may be used to access the resources of the cloud 110, and may include, for example, personal computers (PCs), workstations, laptop computers, tablet computers, mobile phones, personal digital assistants (PDAs) or the like. In one embodiment, user devices 120 may be personal computing devices used by individuals to shop for or browse travel properties (e.g., hotels, motels, bed and breakfasts, condominiums, houses). Property devices 130 may be computing devices used by property managers, owners, or employees to access demand forecasting, profit maximization or other resources available in cloud 110. Cloud 110 may include a group of networked computing resources accessible to the user devices 120 and property devices 130 over a network, such as a local area network (LAN), a wide area network (WAN), a global area network (GAN) such as the Internet, or a combination of such networks. The resources available in the cloud 110 may include, for example, processing devices, storage devices, applications, or other resources. The cloud 110 allows for a functional separation between the computing resources used, the user devices 120 where a user is working, and the property devices 130 where a property manager or owner is working. The cloud 110 may provide access to a vast network of computing resources and allow individuals to use data or resource intensive applications driven by cloud technology which may or may not be available locally given the limitations of the user devices 120 or the property devices 130.

In one embodiment cloud 110 includes cloud platform 112, travel sessionizer 114, profit optimization module 116, one or more application servers (or application server instances) 118, and one or more storage devices 119. Each of these resources may be located at the same location or at different locations, and may be connected to one another and/or to user devices 120 and property devices 130 through the network, as discussed above. Storage devices 119 may be, for example, memory, such as read-only memory (ROM), flash memory, random access memory (RAM), etc., or mass storage devices, such as a magnetic or optical storage devices, or a combination thereof. In one embodiment, user devices 120 and property devices 130 may interact directly with could platform 112. Cloud platform 112 may include software configured to provide access to the other resources in the cloud 110. Cloud platform 112 may cause the cloud resources, such as application servers 118 or storage devices 119, to appear, for example, as web pages or as virtual machines on user devices 120 or property devices 130.

Cloud platform 112 may pass messages between user devices 120 and property devices 130, and travel sessionizer 114 and profit optimization module 116. In one embodiment, travel sessionizer 114 captures raw event data from the travel shopping actions of users on user devices 120 and parses the raw event data into separate travel sessions. In one embodiment, a travel session includes the shopping, browsing, searching etc., done by one individual (or on one of user devices 120) for travel on a set of similar dates. For example, a travel session may include the searches performed by a user for travel over a certain weekend, or travel within several days of that weekend. The data associated with the search, including, for example, a destination city, specific properties, dates of arrival, length of stay, room type, property amenities, price quotes, availability information, and/or other travel information, may be included in a specific travel session associated with the user. Thus, the data in a give travel session is associated with a single trip. Travel sessionizer 114 may store this travel session data on one of storage devices 119 in cloud 110. If travel sessionizer 114 determines that the user makes additional searches for the same trip, travel sessionizer 114 may add any additional data to the same travel session. Additional details regarding travel sessionizer 114 will be provided below.

In one embodiment, profit optimization module 116 uses the travel session data identified by travel sessionizer 114 to forecast the demand at a given property on a certain date and determine a price for rooms at the property on that date that will increase or optimize the profit. Property managers, owners or employees using property devices 130 can access the findings of profit optimization module 116 and choose to implement the suggested prices in the sale of rooms at the property. Additional details regarding profit optimization module 116 will be provided below.

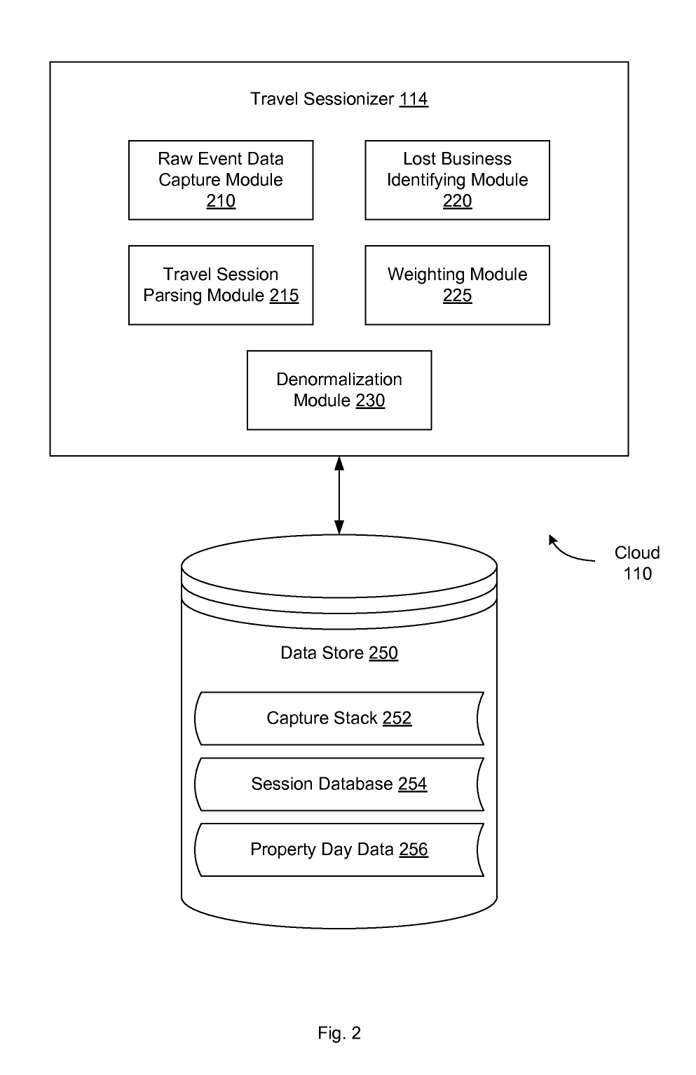

FIG. 2 is a block diagram illustrating a travel sessionizer, according to an embodiment of the present invention. In one embodiment, travel sessionizer 114 may be implemented by one of application servers 118 in cloud 110, as shown in FIG. 1. In one embodiment, travel sessionizer 114 includes raw event data capture module 210, travel session parsing module 215, lost business identifying module 220, weighting module 225, and denormalization module 230. In one embodiment, travel sessionizer 114 is connected to a data store 250, which may be a file system, database or other data management layer resident on a data storage device, such as one of storage devices 119, and may include a disk drive, RAM, ROM, database, etc.

In one embodiment, raw event data capture module 210 captures raw event data from users who are shopping, browsing, searching, etc. for travel on one of user machines 120. In one embodiment, a user may search for a property using a travel website running in a web browser. The web browser may use cookies or some other tracking mechanism to capture the raw event data. The raw event data may include an indication of the criteria that the user puts into each travel search. For example, the raw event data may include a destination city, specific properties, dates of arrival, length of stay, room type, property amenities, price quotes, availability information, and/or other travel information. The web browser may transmit these cookies to travel sessionizer 114 where they are received by raw event data capture module 210. In one embodiment, raw event data capture module 210 stores the raw event data in a capture stack 252 in data store 250.

In one embodiment, travel session parsing module 215 parses the raw event data in capture stack 252 into individual travel sessions. In one embodiment, a travel session includes the shopping, browsing, searching, etc., done by one individual (or on one of user devices 120) for travel on a set of similar dates. For example, travel session parsing module 215 may associate all searches done from a single user device 120, with one individual. The user device 120 may be identified, for example, using a fingerprinting technique to identify a unique combination of Internet Protocol (IP) address, browser type, and/or other features associated with an individual. In another embodiment, travel session parsing module 215 may identify an individual using cookies (either first party cookies from a particular travel website, or third party cookies shared across multiple websites), or using login information (e.g., a unique identifier and password combination). The date component of the travel session may be based upon the dates for which the user is searching for travel information. For example, all searches done by the user for the same dates may be considered part of the same travel session. In one embodiment, searches done for dates that are in close proximity, but not exactly the same, may also be included in the same travel session. For example, travel session parsing module 215 may be configured with a threshold (e.g., +/−2 days) for the start and end of a trip. If the user searches for travel on dates that falls within the threshold, travel session parsing module 215 may consider that search to be part of the same travel session. In one embodiment, travel session parsing module 215 stores the travel data corresponding to each travel session in session database 254 of data store 250.

In one embodiment, lost business identifying module 220 identifies instances of lost business from the data in session database 254. Lost business may include, for example, regrets and denials. A regret occurs when an individual is offered a property on a given night for a certain price, but for some reason does not actually book the property. A denial occurs when the individual expresses an interest in booking a property of the given night, but is unable to do so, because, for example, the property is sold out or the requested room type is unavailable. Lost business identifying module 220 can analyze the shopping behaviors of an individual to determine when regrets and denials occur. Lost business identifying module 220 may add an indication of a regret or denial for a particular property to the corresponding entry in session database 254 in response to this determination.

Weighting module 225 may make a determination of the strength of a regret or denial and may assign a corresponding weighting value. For example, each of regrets and denials may be divided into different tiers, where each tier has a different weighting value. In one embodiment, with respect to denials, a first tier with a lower weighting value may include a property that was not included in a list of properties displayed to a user. A second tier, with a higher weighting value, may include a property that was specifically searched for by a user, but was sold out, and the user does not book another property on the same or similar dates. A third tier, with a highest weighting value indicating a strongest denial, may include a property thaws was specifically searched for by a user, but was sold out, and the user goes on to book another property on the same or similar dates. Weighting module 225 may add the weighting value for the regret or denial to the corresponding entry in session database 254.

In one embodiment, denormalization module 230 denormalizes the data in session database 254 to determine the number of regrets and denials for a given property on a certain day. Denormalization module 230 may read each entry in session database 254 to determine if there are any regrets or denials indicated. For each regret or denial, denormalization module 230 may increment a count value for an entry in property day data 256. In property day data 256, there may be a separate entry for each day at each property. The values in each entry represent the number of regrets and denials determined for the associated day at the associated property. In one embodiment, the number of regrets and denials are combined into a single count value. In other embodiments, however, each entry in property day data 256 may have a separate count value for each of regrets and denials.

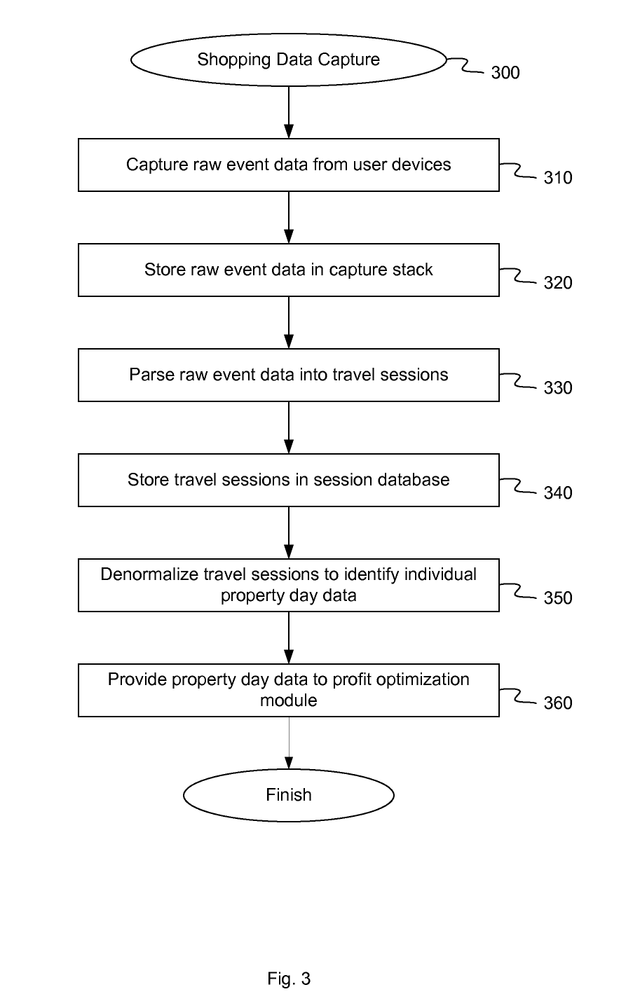

FIG. 3 is a flow diagram illustrating a shopping data capture method, according to an embodiment of the present invention. The method 300 may be performed by processing logic that comprises hardware (e.g., circuitry, dedicated logic, programmable logic, microcode, etc.), software (e.g., instructions run on a processor to perform hardware simulation), or a combination thereof. The processing logic is configured to capture travel shopping data from individual users. In one embodiment, method 300 may be performed by travel sessionizer 114, as shown in FIGS. 1 and 2.

Referring to FIG. 3, at block 310, method 300 captures raw event data from user devices. In one embodiment, raw event data capture module 210 captures raw event data from users who are shopping, browsing, searching, etc. for travel on one of user machines 120. If a user is searching for a property using a travel website running in a web browser, the web browser may use cookies or some other tracking mechanism to capture the raw event data. The raw event data may include an indication of the criteria that the user puts into each travel search. For example, the raw event data may include a destination city, specific properties, date of arrival, length of stay, room type, property amenities, price quotes, availability information, and/or other travel information. The web browser may transmit these cookies to travel sessionizer 114 where they are received by raw event data capture module 210. At block 320, method 300 stores the raw event data in a capture stack 252 in data store 250.

At block 330, method 300 parses the raw event data into separate travel sessions. In one embodiment, travel session parsing module 215 parses the raw event data in capture stack 252 into individual travel sessions. In one embodiment, a travel session includes the shopping, browsing, searching etc., done by one individual (or on one of user devices 120) for travel on a set of similar dates. For example, travel session parsing module 215 may associate all searches done from a single user device 120, with one individual. The data component of the travel session may be based upon the dates for which the user is searching for travel information. At block 340, method 300 stores the travel data corresponding to each travel session in session database 254 of data store 250.

At block 350, method 300 denormalizes the travel session data to identify individual property day data. In one embodiment, denormalization module 230 denormalizes the data in session database 254 to determine the number of regrets and denials for a given property on a certain day. Denormalization module 230 may read each entry in session database 254 to determine if there are any regrets or denials indicated. For each regret or denial, denormalization module 230 may increment a count value for an entry in property day data 256. In property day data 256, there may be a separate entry for each day at each property. The values in each entry represent the number of regrets and denials determined for the associated day at the associated property. At block 360, method 300 provides the property day data 256 to profit optimization module 116, or to another application running on one of application servers 118 or elsewhere, for additional processing.

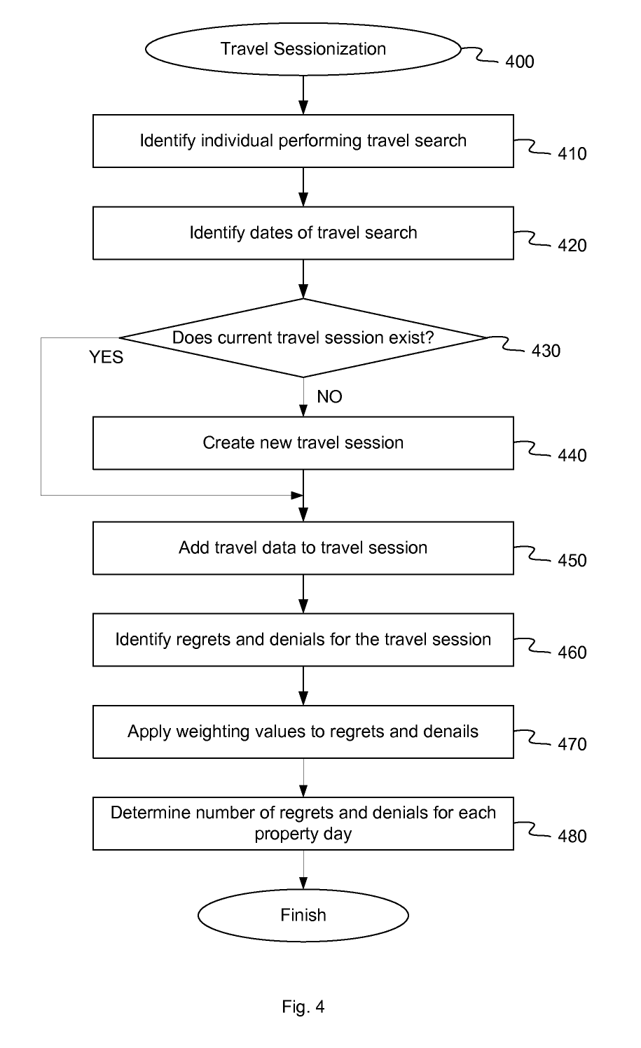

FIG. 4 is a flow diagram illustrating a travel sessionization method, according to an embodiment. The method 400 may be performed by processing logic that comprises hardware (e.g., circuitry, dedicated logic, programmable logic, microcode, etc.), software (e.g., instructions run on a processor to perform hardware simulation), or a combination thereof. The processing logic is configured to transform the raw event data into a semantic representation of users' travel searches and intents. In one embodiment, method 400 may be performed by travel sessionizer 114, as shown in FIGS. 1 and 2.

Referring to FIG. 4, at block 410, method 400 identifies an individual performing a travel search. In one embodiment, travel session parsing module 215 may associate all searches done from a single user device 120, with one individual. The user device 120 may be identified, for example, using a fingerprinting technique to identify a unique combination of Internet Protocol (IP) address, browser type, and/or other features associated with an individual. In another embodiment, travel session parsing module 215 may identify an individual using cookies (either first party cookies from a particular travel website, or third party cookies shared across multiple websites), or using login information (e.g., a unique identifier and password combination).

At block 420, method 400 identifies the dates of the travel search (e.g., the date of arrival and either the length of stay or the date of departure. The date component of the travel session may be based upon the dates for which the user is searching for travel information. For example, all searches done by the user for the same dates may be considered part of the same travel session. In one embodiment, searches done for dates that are in close proximity, but not exactly the same, may also be included in the same travel session. For example, travel session parsing module 215 may be configured with a threshold (e.g., +/−2 days) for the start and end of a trip. If the user searches for travel on dates that falls within the threshold, travel session parsing module 215 may consider that search to be part of the same travel session.

At block 430, method 400 determines whether a travel session currently exists for the combination of user and dates identifies at blocks 410 and 420. In one embodiment, each travel session in session database 254 is identified by an identifier representing the user and dates. For example, the identifier may be a hash of a unique identifier associated with the user (e.g., a random number, such as the cookie) and the travel dates. In other embodiments, some other identifier may be used. Travel session parsing module 215 may examine each identifier to see if there is an entry matching the current combination of name and dates.

If at block 430, method 400 determines that a travel session does not currently exist, at block 440, method 400 creates a new travel session. In one embodiment, travel session parsing module 215 creates a new entry in session database 254. If at block 430, method 400 determines that a travel session does currently exist, at block 450, method 400 adds the travel data to the current travel session in session database 254. In one embodiment, the travel data includes a destination city, specific properties, date of arrival, length of stay, room type, property amenities, price quotes, availability information, and/or other travel information.

At block 460, method 400 identifies travel events, such as lost business data, including regrets and denials, for the current travel session. In one embodiment, lost business identifying module 220 identifies instances of lost business from the data in session database 254. A regret occurs when an individual is offered a property on a given night for a certain price, but for some reason does not actually book the property. In one embodiment, a regret is recorded right away and later removed if the individual books the property. A denial occurs when the individual expresses an interest in booking a property on a given night, but is unable to do so, because, for example, the property is sold out or the requested room type is unavailable. For a multi-day search, the denial may be recorded on the date of arrival, however, the length of stay may also be recorded. Lost business identifying module 220 can analyze the shopping behaviors of an individual to determine when regrets and denials occur. In one embodiment, lost business identifying module 220 may compare the user's searches made over a period of time, or on different user devices 120, so as not to double count regrets or denials. For example, if one day a user searches for a given hotel on a date in the future, but does not book the property, and then on a later day performs the same search again, lost business identifying module 220 may recognize that both searches are part of the same travel session and only record one regret for the property.

At block 470, method 400 applies weighting values to the regrets and denials identified at block 460. In one embodiment, weighting module 225 may make a determination of the strength of a regret or denial and assigns a corresponding weighting value. For example, each of regrets and denials may be divided into different tiers, where each tier has a different weighting value. In one embodiment, with respect to denials, a first tier with a lower weighting value may include a property that was not included in a list of properties displayed to a user. A second tier, with a higher weighting value, may include a property that was specifically searched for by a user, but was sold out, and the user does not book another property on the same or similar dates. A third tier, with a highest weighting value indicating a strongest denial, may include a property that was specifically searched for by a user, but was sold out, and the user goes on to book another property on the same or similar dates. The weighting value may also be increase based on the intensity of the user's search (e.g., different properties in the same city searched over multiple days). Regrets may also carry more weight if the user ends up booking a different property on the same dates. Weighting module 225 may add the determined weighting value for the regret or denial to the corresponding entry in session database 254.

At block 480, method 400 determines the number of regrets and denials for each property day. In one embodiment, denormalization module 230 denormalizes the data in session database 254 to determine the number of regrets and denials for a given property on a certain day. Denormalization module 230 may read each entry in session database 254 to determine if there are any regrets or denials indicated. For each regret or denial, denormalization module 230 may increment a count value for an entry in property day data 256. In property day data 256, there may be a separate entry for each day at each property. The values in each entry represent the number of regrets and denials determined for the associated day at the associated property. In one embodiment, the number of regrets and denials are combined into a single count value. In other embodiments, however, each entry in property day data 256 may have a separate count value for each of the regrets and denials.

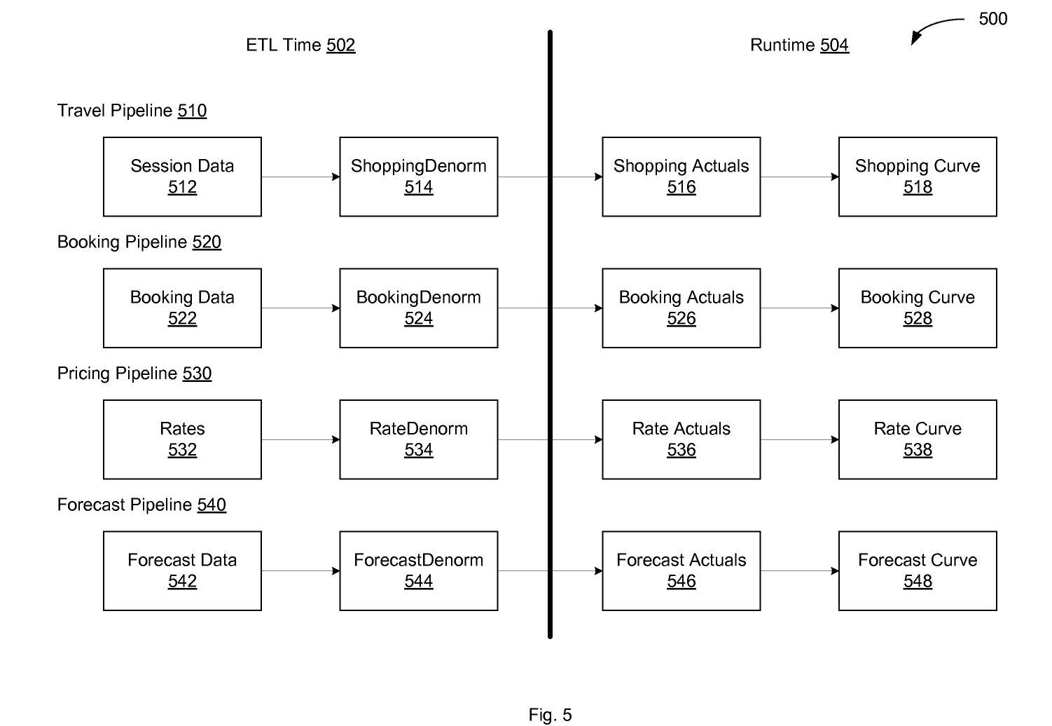

FIG. 5 is a block diagram illustrating data collection pipelines for travel sessionization, according to an embodiment of the present invention. The various modules and components may be described in regards to their roles in collecting and analyzing data with respect to travel sessions, property bookings and prices, as well as demand or other forecasts.

In one embodiment, the processing flow 500 includes travel pipeline 510, booking pipeline 520, pricing pipeline 530, and forecast pipeline 540. In one embodiment, data in each of pipelines 510, 520, 530 and 540, as well as any other pipelines (not shown), may be processed using the same or similar sets of processing logic, instructions and algorithms. For example, other data pipelines including related travel data, such as the number and timing of cancelations for a given property, may also be similarly processed. Having the same or similar processing logic for each pipeline may simplify the operations of travel sessionizer 114, potentially saving time and/or computing resources. In one embodiment, the system not only denormalizes any source system travel event by stay date, but also stores any changes to those stay dates based on when those changes occurred (e.g., the booking or modification date).

In one embodiment, travel pipeline 510 includes session data 512, shoppingDenorm data 514, shopping actuals 516 and shopping curve 518. Travel pipeline 510, as well as all other pipelines, is also divided into two timeframes. In one embodiment, the processing of session data 512 and shoppingDenorm data 514 is performed at extract, transform, load time (ETL time) 502. ETL time 502 is the time when data is extracted from outside sources (e.g., user devices 120), transformed to fit operational needs (e.g., from raw data to session data), and loaded into the target database (e.g., shoppingDenorm data 514 in data store 250). In one embodiment, the processing of shopping actuals 516 and shopping curve 518 is performed at runtime 504. Runtime 504 is the time when a user of property device 130 interacts with travel sessionizer 114 or profit optimization module 116, or a time when a scheduled task is automatically performed. In other embodiments, the processing of data in travel pipeline 510 may occur at other times. For example, shoppingDenorm data 514 may be processed at runtime 504 or shopping actuals 516 may be processed at ETL time 502 or at some other time.

In one embodiment, travel pipeline 510 begins with session data 512. Session data 512 may be data pulled from session database 254 of data store 250. As described above, travel session parsing module 215 parses the raw event data in capture stack 252 into individual travel sessions. In one embodiment, a travel session includes the shopping, browsing, searching, etc., done by one individual (or on one of user devices 120) for travel on a set of similar dates. For example, travel session parsing module 215 may associate all searches done from a single user device 120, with one individual. The date component of the travel session may be based upon the dates for which the user is searching for travel information. For example, all searches done by the user for the same dates may be considered part of the same travel session. In one embodiment, searches done for dates that are in close proximity, but not exactly the same, may also be included in the same travel session. For example, travel session parsing module 215 may be configured with a threshold (e.g., +/−2 days) for the start and end of a trip. If the user searches for travel on dates that fall within the threshold, travel session parsing module 215 may consider that search to be part of the same travel session. In one embodiment, session data 512 may include multiple sessions, and each session may include data pertaining to multiple properties and/or across multiple days (e.g., the length of the trip searched for by the session user).

In one embodiment, session data 512 is followed by shoppingDenorm data 514. ShoppingDenorm data 514 may correspond to property day data 256 of data store 250. In one embodiment, denormalization module 230 denormalizes the session data 512 to organize the data, including regrets and denials, by a given property on a certain day. Denormalization module 230 may read each entry in session data 512 to determine if there are any regrets or denials indicated. For each regret or denial, denormalization module 230 may increment a count value for an entry in shoppingDenorm data 514. ShoppingDenorm data 514 may include a separate entry for each day at each property. The values in each entry represent the number of regrets and denials determined for the associated day at the associated property. Thus, shoppingDenorm data 514 is a rotated view of the same data present in session data 512, but organized by property day (i.e., a certain day at the given property) rather than by travel session (i.e., user and date range).

In one embodiment, shopping actuals 516 include known data points about each future date represented in shoppingDenorm data 514. For example, shopping actuals 516 may include the number of users who searched for travel on a given day in the future. This number may be further broken down by other categories (such as property type, location, rating, segment, etc.). The resulting shopping actuals 516 thus illustrate how many people were shopping, on a given day in the past, for travel on a given day in the future. For example, if the day of travel is November 12, the shopping actuals 516 can show the number of users who searched for travel on November 12 on the days leading up to November 12 (e.g., October 25, October 26, October 27, etc.) up until “today,” (i.e., the day the processing is performed). Since shopping actuals 516 only include “actual” measured data, the actuals 516 may be limited to past days (e.g., prior to and/or including “today”). In one embodiment, the data for shopping actuals 516 may be stored in a numerical or text format. This data may be displayed to a user, upon request, in an easy to read bar or line graph, indicating the change over time.

In one embodiment, shopping curve 518 includes a forecast or prediction for future days. Shopping curve 518 may include the actual data up until “today” from shopping actuals 516, plus the forecasted demand determined by profit optimization module 116. Details of how profit optimization module 116 predicts demand, as well as other data points, are provided below. Thus, if “today” is October 30, shopping curve 518 may include the forecasted demand for travel on November 12 that will be experienced on October 31, November 1, November 2, etc., up until November 12. The data for shopping curve 518 may also be stored in a numerical or text format. This data may be similarly displayed to a user, upon request, in an easy to read bar or line graph, either with or without the data from shopping actuals 516.

As discussed above, similar processing logic, instructions and algorithms may be used for each of the remaining pipelines 520, 530 and 540. Each pipeline, however, includes different data. In one embodiment, booking pipeline 520 begins with booking data 522. The booking data 522 may be obtained, for example, from a reservations engine or a property management system (PMS) running either in cloud 110 or on one of property devices 130. The booking data 522 may include actual bookings or reservations made by a user. The booking data 522 may be rotated (e.g., by denormalization module 230) to form bookingDenorm data 524, which is organized by bookings for a given property on a certain day. Booking actuals 526 and booking curve 528 may include the actual bookings and predicted bookings, respectively, for a given day.

In one embodiment, pricing pipeline 530 begins with rate data 532. Rate data 532 may include the rates offered for a property for future days, as of a specific day (e.g., “today” or some day in the past). The rate data 532 may be obtained, for example, from the reservations engine or PMS running either in cloud 110 or on one of property devices 130. The rate data 532 may be rotated (e.g., by denormalization module 230) to form rateDenorm data 534, which is organized by day and includes the rates offered for that day by a certain property on days in the past leading up to the day of arrival. Rate actuals 536 and rate curve 538 may include the actual rates and predicted rates, respectively, for a given day at the property.

Another feature of the logic and algorithms used to process data is that they may also be used to process forecasts made by profit optimization module 116. In one embodiment, forecast pipeline 540 may begin with forecast data 542. Forecast data 542 may include the forecasted demand, bookings, prices, etc. for a property for future days, as of a specific day (e.g., “today” or some day in the past). The forecast data 542 may be obtained, for example, from profit optimization module 116, as will be described further below. The forecast data 542 may be rotated (e.g., by denormalization module 230) to form forecastDenorm data 544, which is organized by day and includes the forecasts for that day for a certain property on days in the past leading up to the day of arrival. Forecast actuals 546 and forecast curve 548 may include the actual forecasts and predicted future forecasts, respectively, for a given day at the property.

As described above, generally the actuals include actual data from days in the past and/or including data from “today” (i.e., the day the processing is performed). However, the concept of “today” may be more flexible in certain embodiments. For example, a user of property machine 130 may request to view the forecast actuals 546 and curve 548 with respect to some other date. For example, a day (e.g., September 18) from the previous month may be set as “today.” As a result, the forecast actuals 546 would include that actual forecasts for the days up to and including September 18 and the forecast curve 548 would begin on September 19 and proceed into the future. This flexible concept of “today” may be similarly applied in other processing pipelines.

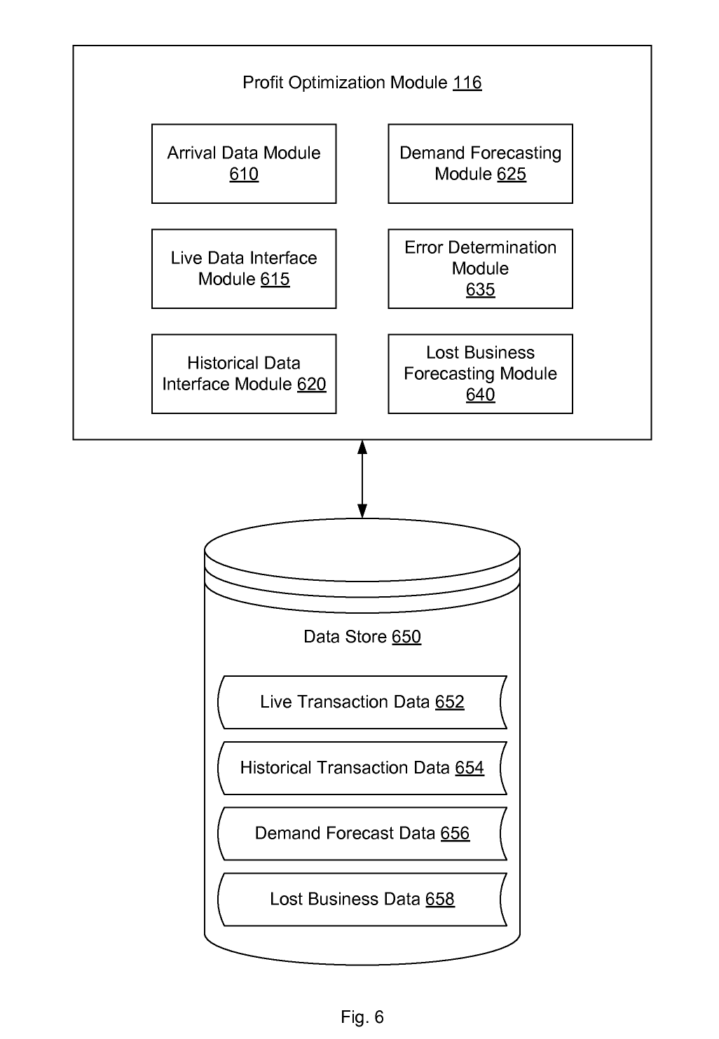

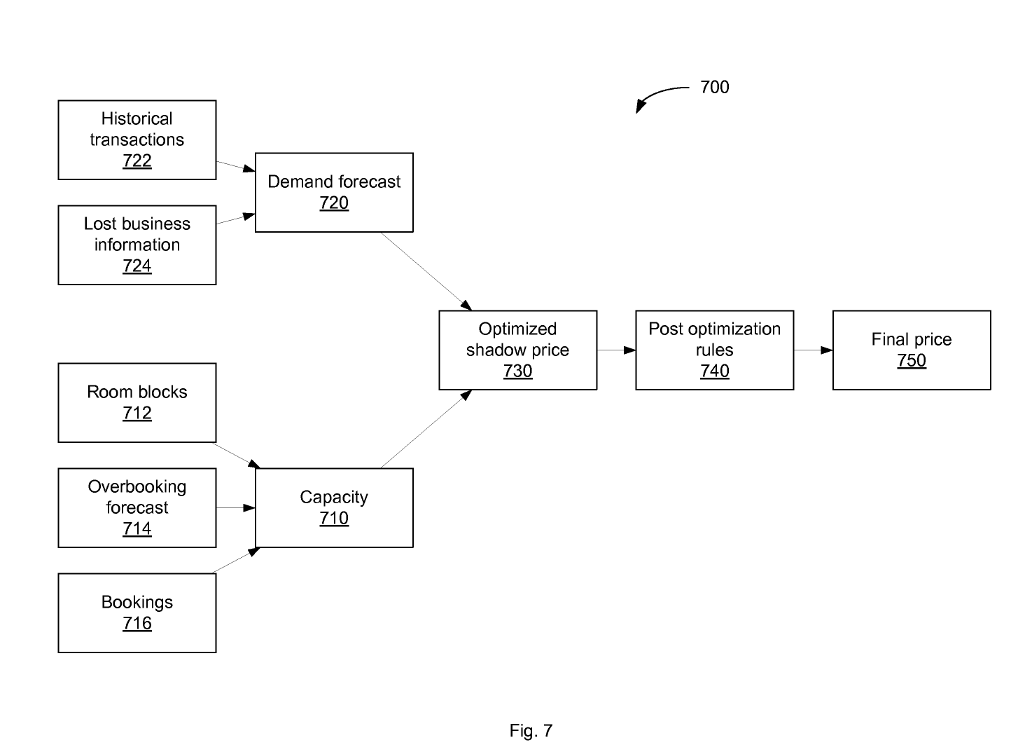

FIG. 6 is a block diagram of one embodiment of a profit optimization module 116 that is included in cloud 110 of FIG. 1. In one embodiment, profit optimization module 116 may include arrival data module 610, live data interface module 615, historical data interface module 620, demand forecasting module 625, error determination module 635 and lost business forecasting module 640. In one embodiment, profit optimization module 116 is connected to a data store 650, which may be a file system, database or other data management layer resident on a data storage device, such as one of storage devices 119, and may include a disk drive, RAM, ROM, database, etc. Additional details of profit optimization module 116 and the sub-modules contained therein are provided below with respect to FIGS. 7-11.

FIG. 7 is a block diagram illustrating a profit optimization processing flow, according to an embodiment of the present invention. The various modules and components may be described in regards to their roles in determining a price for one unit of lodging (e.g., a hotel room) that will optimize the profit for the owner of the property.

In one embodiment, the processing flow 700 begins with determining a capacity for the property on a given day at block 710. In one embodiment, for ease of explanation, the day for which the capacity is determined may be referred to as the “day of arrival” or the “arrival day,” although it should be understood that a guest need not necessarily arrive at the property on that day, but rather just make a reservation for that day/night. For example, the guest may have checked-in to the property on an earlier day, but their stay includes the “day of arrival.” The capacity may take into account several factors including, among others, the physical number of rooms in the property, room blocks 712, an overbooking forecast 714, and previous bookings 716. Room blocks 712 may include blocks of rooms (or other lodging units) that are being held or reserved for a specific guest or group, but have not been officially booked. For example, commonly a block of rooms may be reserved for guests of a wedding or attendees of a conference, while the individuals may actually book the rooms themselves at a later date. The overbooking forecast 714 may designate a number of rooms or a percentage of rooms of the actual physical capacity of the hotel that may be booked to account for cancelations and no-shows. In one embodiment, there is a default number of rooms (e.g. 5) or a percentage of the total rooms in the property (e.g., 5%) that may be overbooked. In another embodiment, the overbooking forecast 714 may include an estimate of how many rooms to overbook based on historical trends for cancelations and no-shows. Previous bookings 716 may a number of rooms that were previously booked by guests for the day of arrival. These bookings may be subtracted from the physical capacity of the property in order to determine the capacity 710 for the property on the day of arrival. In one embodiment, room blocks 712, the overbooking forecast 714 and previous bookings 716 are obtained from a booking engine or central reservation system associated with the property.

At block 720, the demand for lodging units is forecasted for the day of arrival. In one embodiment, historical transactions 722 and lost business information 724 are combined to determine the demand forecast 720. Historical transactions 722 may include the number of bookings made at the property in the past. In one embodiment, trends may develop over time for the same day of the week. Thus, historical transactions 722 may include, for example, the number of bookings made for the same day of the week as the day of arrival during some number of previous weeks. In another embodiment, historical transactions 722 may include the number of bookings made within some period of time (e.g., 5 days) of the day of arrival during some number of previous weeks. In other embodiments, some other historical transaction data may be used. Lost business information 724 may include regrets and denials that did not result in an actual booking for the property. Regrets are generated when a potential customer searches for or inquires about a room at the property but does not ultimately book the room. Denials are generated when a potential customer is unable to book a room because either the property or the specific room type that they are searching for is sold out or otherwise unavailable on the day of arrival. This lost business information 724 can be informative of the interest in the property on the day in question and may affect the demand forecast 720. In one embodiment, historical transaction data 722 may be obtained from the booking engine or central reservation system associated with the property, and lost business information 724 may be obtained from travel sessionizer 114, as described above. Additional details of the demand forecast 720 will be described below.

The capacity 710 and the demand forecast 720 are combined to generate the optimized shadow price 730. In one embodiment, the shadow price represents the highest price that a property can charge for an extra room at the property (and have the room be booked) based on the forecasted demand 720. For example, if the offer price for a room at the property is above the shadow price, it is unlikely that a booking will result, because the demand forecast 720 cannot support that price. If the offer price is below the shadow price, the room will likely be booked, but the property could likely have gotten a higher price for the room. If the offer price is equal to the shadow price, the property can likely optimize its profit, by obtaining a booking at the highest possible price for the extra room. In one embodiment, the shadow price is determined based on prices charged in historical transactions 722 and adjusted based on the forecasted demand. For example, if the forecasted demand is higher than the actual demand was at a certain time in the past, the shadow price may be increased from what the actual offer price was at that time in the past.

After the optimized shadow price 730 is determined, additional post optimization rules 740 may be enforced. Post optimization rules 740 can be used to vary the final price 750 from the optimized shadow price 730 according to preferences of the property owner/manager. Post optimization rules 740 may have default settings or alternatively may be controlled by the property owner/manager or by any user of the profit optimization engine. In one embodiment, price elasticity and the propensity of customers to pay a certain price, can be determined from the lost business data 724. This information can be incorporated in the post optimization rules 740 to modify the optimized shadow price 730. For example, if the shadow price 730 for the day of arrival is $100, but it is determined that customers in a specific segment are price insensitive for that day (e.g., if they are coming on business and they are on an expense account), the final price 750 can be adjusted above $100. If by looking at the data, it is determined that the customers in a segment are indifferent to paying $109 or $139 for a room (this may be seen in the data aggregated for a market), then a post optimization rule 740 for that day can modify the original $100 shadow price 730 into a $139 final selling price 750 for that segment.

In another embodiment, the post optimization rules 740 can also be based on marketing or management decisions. For example, the manager of a property may want rooms at his hotel to be priced on a specific channel at least $10 above a competing property. A post optimization rule 740 may be set to increase the final price 750 to $10 above the competitor's price for the day of arrival. Other post optimization rules 740 can deal with minimum selling rate by day of week and/or season or a maximum selling rate (e.g., the marketing department always wants to make sure the price 750 never goes below a given price or above another price). The final price 750, as modified by the post optimization rules 740 may be displayed to customers in a given segment for the day of arrival.

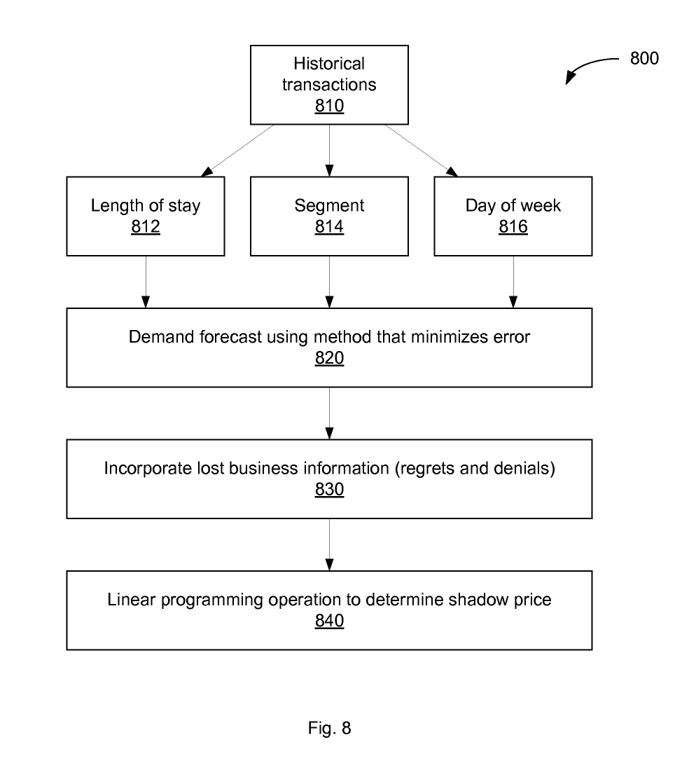

FIG. 8 is a block diagram illustrating a demand forecasting processing flow, according to an embodiment of the present invention. The various modules and components may be described in regards to their roles in forecasting the demand for a property on a given day in the future.

In one embodiment, the processing flow 800 begins with dividing historical transaction data 810 into a number of usable buckets. The historical transactions 810 may include information about bookings made at the property in the past. In one embodiment, historical transaction data 810 may be obtained from a booking engine or central reservation system associated with the property. The buckets into which historical transaction data 810 is divided may be groups of data that share similar characteristics. For example, one bucket may include the length of stay 812 for a booking at the property. In one embodiment, each transaction where a user books one or more consecutive nights at a property may be grouped together with other transactions booked for the same period of time (e.g., 1 night, 2 nights, 3 nights, etc.). In another embodiment, if the number of transactions in any one bucket is too low (e.g., below a defined threshold), one or more buckets may be combined. For example, if it is recognized that certain characteristics of transactions having a length of stay of 3 nights and 4 nights are similar, all of those transactions may be grouped together into a single bucket, for certain processing operations. Another bucket may include the segment 814 to which a customer belongs. Segments 814 may include groups of customers that exhibit a similar booking behavior. Examples of segments 814 may include customers that are part of a group staying at the property (e.g., for a wedding or a conference) and customers that book through a certain channel (e.g., property website, travel website, telephone, in-person). The segments 814 that make up one of the buckets may be set to default values or may be configurable by the user of the system. Another bucket may include the day of the week 816 on which the day of arrival falls. In one embodiment, trends may develop over time for the same day of the week. Thus, historical transactions 810 may include, for example, the number of bookings made for the same day of the week 816 as the day of arrival during some number of previous weeks. In another embodiment, if the number of transactions in any one bucket is too low (e.g., below a defined threshold), one or more buckets may be combined. For example, if it is recognized that certain characteristics of transactions on Tuesdays and Wednesdays are similar, all of those transactions may be grouped together into a single bucket, for certain processing operations. In another embodiment, historical transactions 810 may include the number of bookings made between the current day (i.e., the “day of forecast”) and the day of arrival. The bookings made during this period of time (e.g., 5 days) during some number of previous weeks may be relevant. In other embodiments, historical transactions 810 may be divided into one or more of these buckets or other buckets not specifically described herein.

The data from each of buckets 812, 814 and 816 may be used to determine a demand forecast 820 using a method that minimizes a forecasting error. Examples of demand forecasting methods may include regression, a moving average, exponential smoothing, Bayesian, or some other forecasting method. Regression analysis may include a technique for forecasting demand based on the relationship of a number of independent variables including, for example, date, day of the week, location of the property, price of the room, or others. A moving average may include the average of a fixed sample (e.g., the bookings from a number of previous weeks) that is continuously shifted forward in time (i.e., to include only the most recent data). Exponential smoothing may include an average of the number of bookings from the past weeks that are weighted with exponentially decreasing values over time, so that the more recent data is weighted more heavily in forecasting the demand. A Bayesian average may be used to forecast the demand, but instead of estimating the average strictly from the previous booking information, other existing information related to that data may also be incorporated into the calculation in order to minimize the impact of large deviations. In one embodiment, the demand forecast 820 may be dynamically calculated using one or more of these or other forecasting methods and the forecast that is actually used may be the one that minimizes forecasting error. The forecasting error may be measured, for example, based on a median absolute deviation, a mean absolute percentage error, or by some other method.

Upon forecasting the demand 820, lost business information 830 may be incorporated into the forecast. In one embodiment, the lost business information includes regrets and denials that did not result in an actual booking for the property. Regrets are generated when a potential customer searches for or inquires about a room at the property but does not ultimately book the room. Denials are generated when a potential customer is unable to book a room because either the property or the specific room type that they are searching for is sold out or otherwise unavailable on the day of arrival. This lost business information 830 can be informative of the interest in the property on the day in question and may affect the demand forecast 820.

The result of the demand forecast 820, as affected by lost business information 830, can be used to determine the optimized shadow price 840. In one embodiment, the shadow price represents the highest price that a property can charge for an extra room at the property (and have the room be booked) based on the forecasted demand 720. In one embodiment, the shadow price is determined based on prices charged in historical transactions 722 and adjusted based on the forecasted demand.

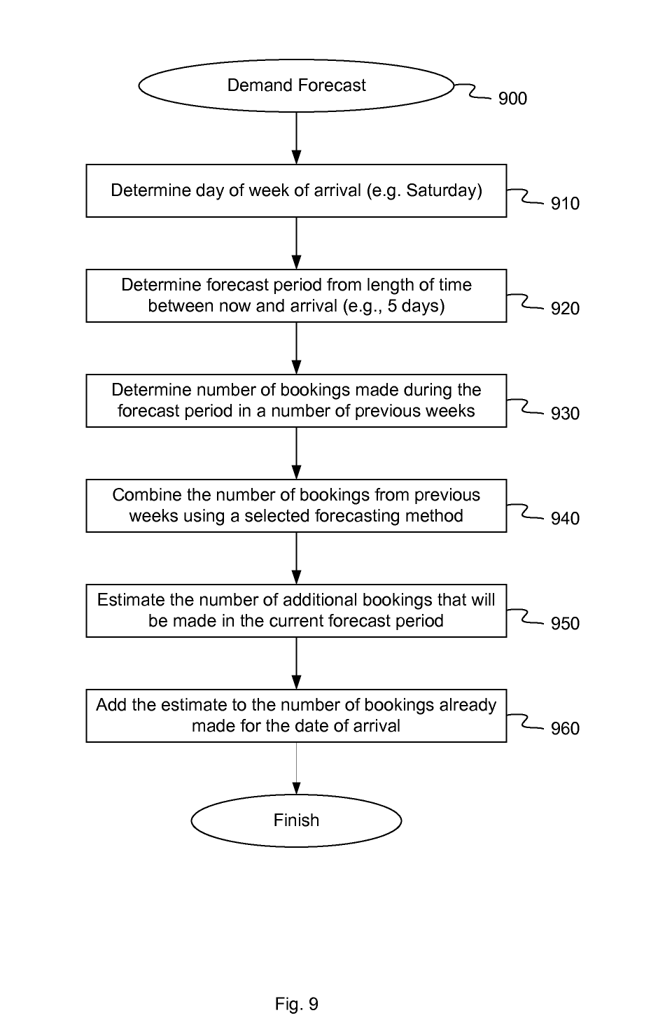

FIG. 9 is a flow diagram illustrating a demand forecasting method, according to an embodiment of the present invention. The method 900 may be performed by processing logic that comprises hardware (e.g., circuitry, dedicated logic, programmable logic, microcode, etc.), software (e.g., instructions run on a processor to perform hardware simulation), or a combination thereof. The processing logic is configured to forecast the demand for a room at a property on a given day in the future. In one embodiment, method 900 may be performed by profit optimization module 116, as shown in FIGS. 1 and 6.

Referring to FIG. 9, at block 910, method 900 determines the day of the week for the designated day of arrival. In one embodiment, arrival data module 610 receives a user selection (e.g., through a user interface) indicating the day of arrival. The day of arrival will be the day for which method 900 will forecast the demand. For example, the day of the week of the day or arrival may be a Saturday. At block 920, method 900 determines a forecast period based on the length of time between the current day and the day of arrival. For example, if the current day is a Monday, arrival data module 610 may determine that the forecast period between now and the following Saturday is five days. Thus, the forecast period for the current forecast may be set at five days.

At block 930, method 900 determines the number of bookings made during the forecast period in some number of previous weeks. In one embodiment, historical data interface module 620 may examine historical transaction data 654 from some number of previous weeks. In one embodiment, the number of previous weeks may be a default value (e.g., 13 weeks) or the number of previous weeks may be user configurable. In other embodiments, the number of previous weeks examined may be varied depending on a number of factors, such as the season, the location of the property, etc. In one embodiment, historical data interface module 620 may examine the forecast period (e.g., 5 days) prior to the day of week (e.g., Saturday) for the current day of arrival in each of the previous 13 weeks. Historical data interface module 620 may determine how many bookings were made during that period during each of the 13 weeks.

At block 940, method 900 combines the number of bookings determined from the previous weeks at block 930 using a selected forecasting method. In one embodiment, the forecasting method used may be a default method, may be a user-selected method, may be a method selected based on a minimization of forecasting error, or may be some other method. For example, the forecasting method may be regression, a moving average, exponential smoothing, Bayesian, or some other forecasting method. As a result of combining these bookings from the historical transaction data 654, at block 950, method 900 estimates the number of additional bookings that will be made in the current forecast period. Demand forecasting module 625 may determine this demand forecast.

At block 960, method 900 adds the estimate from block 950 to the number of bookings already made for the day of arrival. The number of bookings already made may be determined by live data interface module 615 from live transaction data 652. By adding the estimated bookings between the current data and the day of arrival to the number of bookings already made, demand forecasting module 625 can estimate what the total demand will be for the day of arrival. Demand forecasting module 625 may store this information as demand forecast data 656.

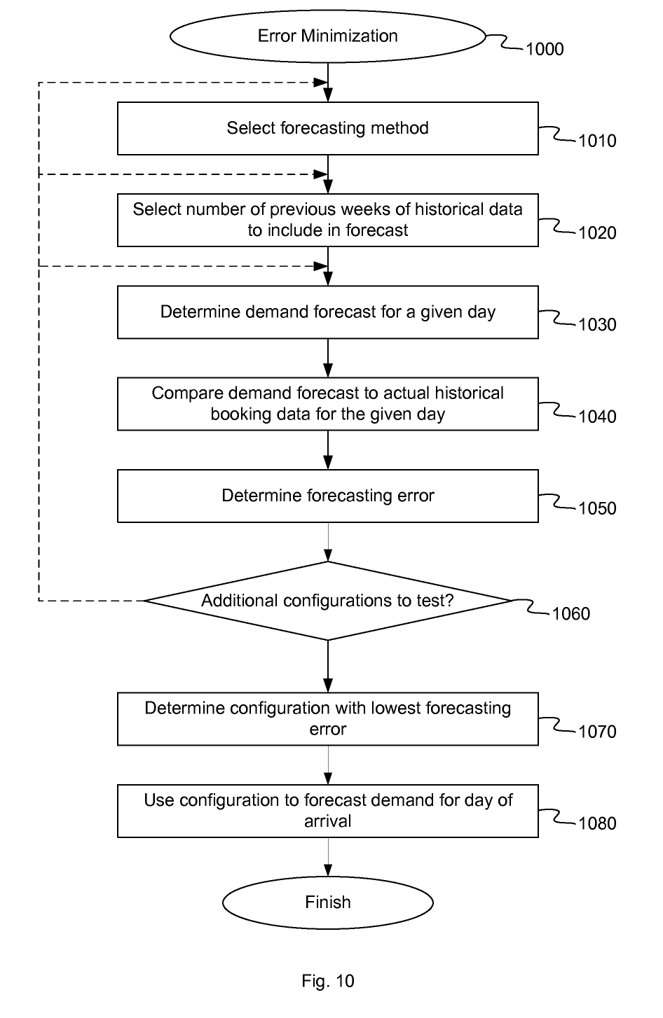

FIG. 10 is a flow diagram illustrating an error minimization method for demand forecasting, according to an embodiment of the present invention. The method 1000 may be performed by processing logic that comprises hardware (e.g., circuitry, dedicated logic, programmable logic, microcode, etc.), software (e.g., instructions run on a processor to perform hardware simulation), or a combination thereof. The processing logic is configured to select a forecasting method that will minimize forecasting error when forecasting demand for a property. In one embodiment, method 1000 may be performed by profit optimization module 116, as shown in FIGS. 1 and 6.

Referring to FIG. 10, at block 1010, method 1000 selects a first forecasting method. Error determination module 635 may select one of the available forecasting methods or receive an indication of a selected forecasting method from a user. In one embodiment, the forecasting methods may include, for example, regression, a moving average, exponential smoothing, Bayesian, or some other forecasting method. At block 1020, method 1000 selects the number of previous weeks of historical transaction data 654 to include in the forecast. In one embodiment, the number of previous weeks may be a default value (e.g., 13 weeks) or the number of previous weeks may be user configurable. In other embodiments, the number of previous weeks examined may be varied depending on a number of factors, such as the season, the location of the property, etc.

At block 1020, method 1000 determines the demand forecast for a given day. In one embodiment, the given day may be the same day of the week as the day of arrival, but from a previous week (e.g., one week prior), so that actual transaction data for that day is known. Thus, for example, if the day of arrival is the upcoming Saturday, demand forecasting module 625 may determine the demand forecast for the previous Saturday according to method 900, using the forecasting method selected at block 1010, as described above. In other embodiments, demand forecasting module 625 may determine the forecast for some other day. At block 1040, method 1000 compares the demand forecast determined at block 1030 to the actual demand data for that day. The demand forecast determined at block 1030 may be referred to as a test forecast. In one embodiment, error determination module 635 reads historical transaction data 654 for the previous Saturday and compares that data to the demand forecast data 656 calculated for that day.

At block 1050, method 1000 determines a forecasting error for the demand forecast. In one embodiment error determination module 635 determines the forecasting error, for example, based on a median absolute deviation, a mean absolute percentage error, or by some other method. The median absolute deviation may be expressed as the median of the absolute deviations of each sample in the data from the data's median. The mean absolute percentage error may be expressed as the sum, for each forecasted value, of the difference between the actual value and the forecasted value divided by the actual value, all of which is multiplied by 100 to determine a percentage error. In general the lower either the median absolute deviation or the mean absolute percentage error, the more accurate the forecast was.

At block 1060, method 1000 determines if there are additional configurations to test. The configurations that are tested may be configurable by a user. In one embodiment, method 1000 may return to block 1030 and determine a demand forecast for a different day. For example, demand forecasting module 625 may determine the demand forecast for some other Saturday in the past, besides the most recent Saturday. In one embodiment, error determination module 635 may determine the forecasting error for that Saturday as well. Error determination module 635 may also combine (e.g., average, weighted average, etc.) the forecasting errors for each day that is tested in order to determine an overall forecasting error for the selected forecasting method. In another embodiment, method 1000 may return to block 1020 and select a different number of previous weeks of historical data to include in the forecast. For example, historical data interface module 620 may retrieve fewer weeks of historical transaction data 654 (e.g., 6 weeks) or more weeks (e.g., 15 weeks). In yet another embodiment, method 1000 may return to block 1010 and select a different forecasting method than the one that was previously tested. In one embodiment, method 1000 may repeat each of the following steps for each change in configuration. In one embodiment, method 1000 may test all possible configurations, or some subset of configurations (e.g., each of the different forecasting methods), to determine which configuration has the lowest forecasting error.

At block 1070, method 1000 compares the determined forecasting error for each of the configurations tested. In one embodiment, error determination module 635 determines which configuration resulted in the lowest forecasting error (i.e., based on either median absolute deviation or a mean absolute percentage error). At block 1080, method 1000 selects the configuration determined at block 1070 to use to forecast the demand for the current day of arrival (e.g., this coming Saturday). In one embodiment, profit optimization module 116 may perform the steps of method 1000 prior to each demand forecast that is made. In this manner, the forecasting method and associated configuration is dynamically selected to give the best possible forecast.

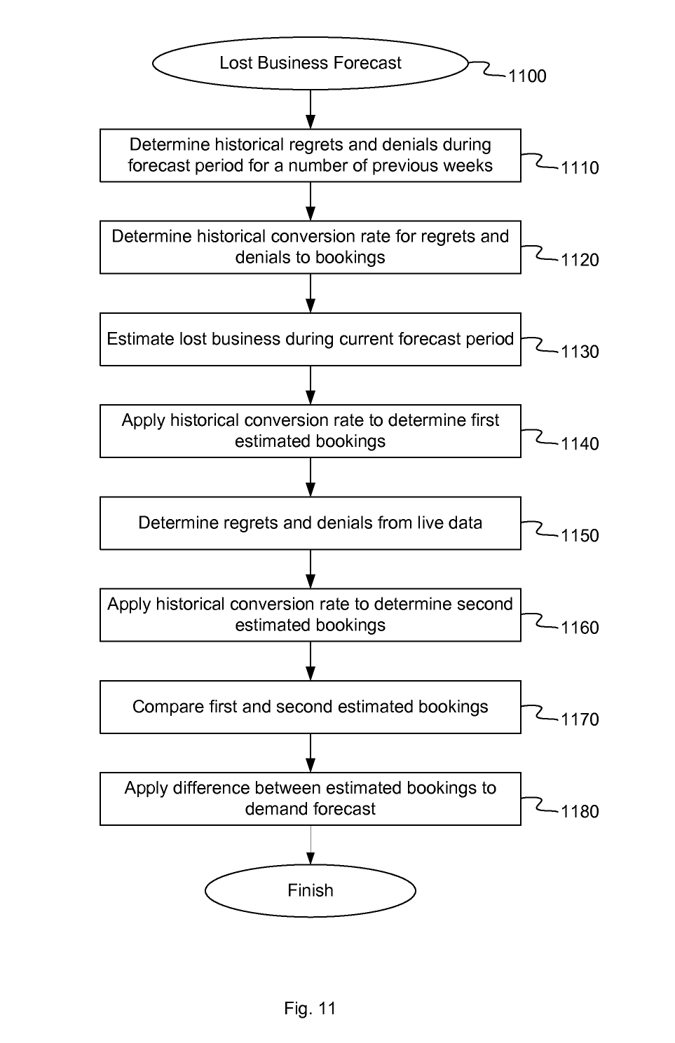

FIG. 11 is a flow diagram illustrating a lost business forecasting method, according to an embodiment of the present invention. The method 1100 may be performed by processing logic that comprises hardware (e.g., circuitry, dedicated logic, programmable logic, microcode, etc.), software (e.g., instructions run on a processor to perform hardware simulation), or a combination thereof. The processing logic is configured to forecast the amount of lost business data that will affect the demand for a property. In one embodiment, method 1100 may be performed by profit optimization module 116, as shown in FIGS. 1 and 6.

Referring to FIG. 11, at block 1110, method 1100 determines historical lost business data during the forecast period for a number of previous weeks. In one embodiment, where the forecast period is 5 days and the day of arrival is a Saturday, historical data interface module 620 can retrieve lost business data 658, including regrets and denials from the 5 day period prior to each Saturday in some number of previous weeks. In one embodiment, historical data interface module 620 may retrieve the regrets and denials for 13 previous weeks, although in other embodiments, this number may be configurable.

At block 1120, method 1100 determines the historical conversion rate for regrets and denials generating actual bookings. In one embodiment, lost business forecasting module 640 examines the lost business data 658 and compares those numbers to historical transaction data 654 for the same period. For example, if during the forecasting period from the previous week, there were 200 regrets and denials and 10 actual bookings, lost business forecasting module 640 can determine a conversion rate of 5%. In one embodiment, lost business forecasting module 640 may determine the average conversion rate over the same or a different number of previous weeks.

At block 1130, method 1100 estimates the lost business during the current forecast period. In one embodiment, lost business forecasting module 640 performs a method, which may be similar to demand forecasting method 900, but using lost business data instead of actual bookings. For example, lost business forecasting module 640 may use a forecasting method, such as one of regression, a moving average, exponential smoothing, Bayesian, or some other forecasting method to mathematically combine the historical regrets and denials determined at block 1110, and generate and estimate of how many regrets and denials will occur during the current forecast period (i.e., between now and the day of arrival).

At block 1140, method 1100 applies the historical conversion rate determined at block 1120 to the estimated number of regrets and denials determined at block 1130 to determine an estimated number of bookings. For example, if there are an estimated 300 regrets and denials during the forecast period and the historical conversion rate is 5%, then lost business forecast module 640 may determine that there will be an estimated 15 additional bookings during the forecast period. This represents the number of expected bookings, assuming that the number of regrets and denials followed historical norms.

At block 1150, method 1100 determines the actual current regrets and denials. In one embodiment, live data interface module 615 can retrieve the current regrets and denials from live transaction data 652. At block 1160, method 1100 applies the historical conversion rate determined at block 1120 to the live regrets and denials. For example, if the actual number of regrets and denials is 250, lost business forecasting module can multiply that number by 5% to determine that there will likely be 12 bookings resulting from those regrets and denials.

At block 1170, method 1100 compares the estimated bookings from block 1140 to the estimated bookings from block 1170. In one embodiment, lost business forecasting module 640 determines the difference between the two estimates. In this example, there are 3 less estimated bookings based on the actual lost business information as compared to the historical lost business information. Accordingly, at block 1180, method 1100 applies this difference to the demand forecast. In one embodiment, lost business forecasting module 640 subtracts the 3 bookings from the demand forecast calculated at block 950 of method 900 or block 1080 of method 1000. This adjustment based on the lost business forecast, may result in a more accurate demand forecast for the property.

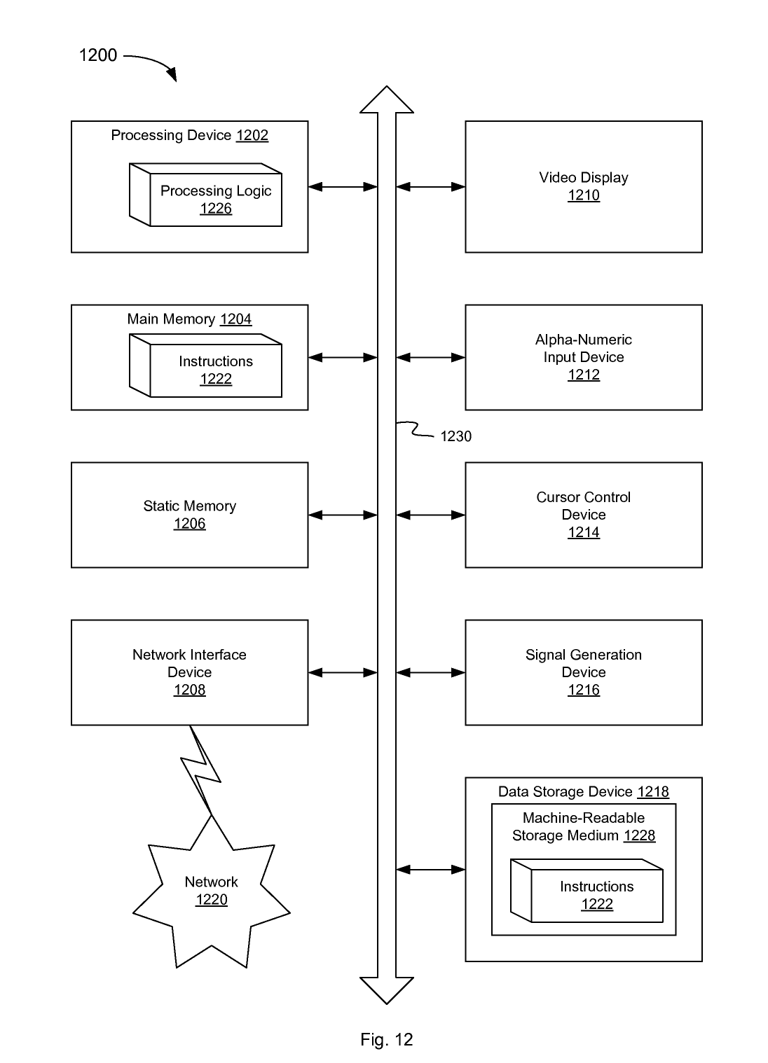

FIG. 12 illustrates a diagrammatic representation of a machine in the exemplary form of a computer system 1200 within which a set of instructions, for causing the machine to perform any one or more of the methodologies discussed herein, may be executed. In alternative embodiments, the machine may be connected (e.g., networked) to other machines in a local area network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. In one embodiment, computer system 1200 may be representative of a computing device, such as user device 120, property device 130 or a computer used to support cloud 110.

The exemplary computer system 1200 includes a processing device 1202, a main memory 1204 (e.g., read-only memory (ROM), flash memory, dynamic random access memory (DRAM) (such as synchronous DRAM (SDRAM) or Rambus DRAM (RDRAM), etc.), a static memory 1206 (e.g., flash memory, static random access memory (SRAM), etc.), and a data storage device 1218, which communicate with each other via a bus 1230. Any of the signals provided over various buses described herein may be time multiplexed with other signals and provided over one or more common buses. Additionally, the interconnection between circuit components or blocks may be shown as buses or as single signal lines. Each of the buses may alternatively be one or more single signal lines and each of the single signal lines may alternatively be buses.

Processing device 1202 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 1202 may also be one or more special-purpose processing devices such as an application specific integrated circuit (ASIC), a field programmable gate array (FPGA), a digital signal processor (DSP), network processor, or the like. The processing device 1202 is configured to execute processing logic 1226 for performing the operations and steps discussed herein.

The computer system 1200 may further include a network interface device 1208. The computer system 1200 also may include a video display unit 1210 (e.g., a liquid crystal display (LCD) or a cathode ray tube (CRT)), an alphanumeric input device 1212 (e.g., a keyboard), a cursor control device 1214 (e.g., a mouse), and a signal generation device 1216 (e.g., a speaker).

The data storage device 1218 may include a machine-accessible storage medium 1228, on which is stored one or more set of instructions 1222 (e.g., software) embodying any one or more of the methodologies of functions described herein. The instructions 1222 may also reside, completely or at least partially, within the main memory 1204 and/or within the processing device 1202 during execution thereof by the computer system 1200; the main memory 1204 and the processing device 1202 also constituting machine-accessible storage media. The instructions 1222 may further be transmitted or received over a network 1220 via the network interface device 1208.

The machine-readable storage medium 1228 may also be used to store instructions for sessionizing travel data, forecasting demand and optimizing profits at a travel property, as described herein. While the machine-readable storage medium 1228 is shown in an exemplary embodiment to be a single medium, the term “machine-readable storage medium” should be taken to include a single medium or multiple media (e.g., a centralized or distributed database, and/or associated caches and servers) that store the one or more sets of instructions. A machine-readable medium includes any mechanism for storing information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read-only memory (ROM); random-access memory (RAM); erasable programmable memory (e.g., EPROM and EEPROM); flash memory; or another type of medium suitable for storing electronic instructions.

Although the operations of the methods herein are shown and described in a particular order, the order of the operations of each method may be altered so that certain operations may be performed in an inverse order or so that certain operation may be performed, at least in part, concurrently with other operations. In another embodiment, instructions or sub-operations of distinct operations may be in an intermittent and/or alternating manner.

1. A method comprising:
capturing raw event data from a plurality of user devices, the raw event data representing user shopping behavior from a plurality of users;
parsing the raw event data from the plurality of user devices into one or more travel sessions, wherein each of the one or more travel sessions represents shopping behavior for a single user of the plurality of users, the shopping behavior comprising a plurality of searches performed by the single user, for travel to a plurality of travel properties, and for travel during a specified date range;
denormalizing, by a processing device, the one or more travel sessions to organize travel session data by individual property days, wherein each individual property day represents travel session data corresponding to a separate property on a given day, and wherein denormalizing the one or more travel sessions comprises determining a number of regrets and denials for each of the plurality of travel properties on each of a plurality of days during the specified date range; and
providing the individual property day data to a profit optimization module for further processing.

2. The method of claim 1, wherein parsing the raw event data into one or more travel sessions comprises:
identifying a first user of the user device performing the user shopping behavior; and
identifying the specified date range, wherein a first travel session of the one or more travel sessions comprises a unique combination of the first user and the specified date range.

3. The method of claim 2, wherein the first travel session comprises shopping behavior associated with a second user of the same user device and shopping behavior associated with dates that are within a threshold amount of time from the specified date range.

4. The method of claim 1, further comprising:
identifying lost business data from the travel session data, the lost business data comprising at least one of a regret or a denial;
comparing the raw event data in each travel session to identify repeat searches and removing the repeat searches from a count of the lost business data; and
applying a weighting value to each instance of the lost business data, wherein the weighting value increases proportionally to a user's interest in booking a travel property.

5. The method of claim 4, wherein a regret occurs in the user shopping behavior when a user is offered a first property on a given night for a certain price, but the user does not book the property, and wherein a denial occurs in the user shopping behavior when the user is unable to book the first property on the given night.

6. (canceled)

7. The method of claim 1, wherein the raw event data comprises at least one of booking data, pricing data or forecast data, the method further comprising:
parsing the raw event data into one or more sessions; and
denormalizing the one or more sessions to organize session data by individual property days.

8. A system comprising:
a processing device;
a memory operatively coupled to the processing device, the memory to store a travel sessionizer, executable by the processing device from the memory, the travel sessionizer to:
capture raw event data from a plurality of user devices device, the raw event data representing user behavior from a plurality of users;
parse the raw event data from the plurality of user devices into one or more sessions, wherein each of the one or more sessions represents user behavior for a single user of the plurality of users, the shopping behavior comprising a plurality of searches performed by the single user, for travel to a plurality of travel properties, and for travel during a specified date range;
denormalize the one or more sessions to organize session data by individual property days, wherein each individual property day represents session data corresponding to a separate property on a given day, and wherein to denormalize the one or more travel sessions, the travel sessionizer to determine a number of regrets and denials for each of the plurality of travel properties on each of a plurality of days during the specified date range; and
predict user behavior for future days in view of the individual property day data.

9. The system of claim 8, wherein the raw event data comprises at least one of travel data, booking data, pricing data or forecast data.

10. The system of claim 8, wherein to parse the raw event data into one or more sessions, the travel sessionizer to:
identify a first user of the user device performing the user shopping behavior; and
identify the specified date range, wherein a first session of the one or more sessions comprises a unique combination of the first user and the specified date range.

11. The system of claim 10, wherein the first session comprises user behavior associated with a second user of the same user device and user behavior associated with dates that are within a threshold amount of time from the specified date range.

12. The system of claim 11, wherein the threshold amount of time comprises two days before and two days after the specified date range.

13. The system of claim 8, wherein to denormalize the one or more sessions to organize session data by individual property days, the travel sessionizer to:
read each of a plurality of entries in the session data;
identify travel events from each of the plurality of entries; and
for each identified travel event, increment a count value for an individual property day corresponding to a day in the specified date range.

14. A non-transitory computer-readable storage medium storing instructions which, when executed, cause a processing device to perform operations comprising:
capturing raw event data from a plurality of user devices, the raw event data representing user shopping behavior from a plurality of users;
parsing the raw event data from the plurality of user devices into one or more travel sessions, wherein each of the one or more travel sessions represents shopping behavior for a single user of the plurality of users, the shopping behavior comprising a plurality of searches performed by the single user, for travel to a plurality of travel properties, and for travel during a specified date range; and
denormalizing, by the processing device, the one or more travel sessions to organize travel session data by individual property days, wherein each individual property day represents travel session data corresponding to a separate property on a given day, and wherein denormalizing the one or more travel sessions comprises determining a number of regrets and denials for each of the plurality of travel properties on each of a plurality of days during the specified date range.

15. The non-transitory computer-readable storage medium of claim 14, wherein parsing the raw event data into one or more travel sessions comprises:
identifying a first user of the user device performing the user shopping behavior; and
identifying the specified date range, wherein a first travel session of the one or more travel sessions comprises a unique combination of the first user and the specified date range.

16. The non-transitory computer-readable storage medium of claim 15, wherein the first travel session comprises shopping behavior associated with a second user of the same user device and shopping behavior associated with dates that are within a threshold amount of time from the specified date range.

17. The non-transitory computer-readable storage medium of claim 14, the operations further comprising:
identifying lost business data from the travel session data, the lost business data comprising at least one of a regret or a denial;
comparing the raw event data in each travel session to identify repeat searches and removing the repeat searches from a count of the lost business data; and
applying a weighting value to each instance of the lost business data, wherein the weighting value increases proportionally to a user's interest in booking a travel property.

18. The non-transitory computer-readable storage medium of claim 17, wherein a regret occurs in the user shopping behavior when a user is offered a first property on a given night for a certain price, but the user does not book the property, and wherein a denial occurs in the user shopping behavior when the user is unable to book the first property on the given night.

19. (canceled)

20. The non-transitory computer-readable storage medium of claim 14, the operations further comprising:
providing the individual property day data to a profit optimization module for further processing.
